(19) United States
(12) Patent Application Publication
(10) Pub. No.: US 2025/0135925 A1
(43) Pub. Date: May 1, 2025

(54) Charging Security Device for Electric Work Vehicles

(71) Applicant: Caterpillar Inc., Peoria, IL (US)

(72) Inventor: Thomas L. TWIGGER, Spalding (GB)

(73) Assignee: Caterpillar Inc., Peoria, IL (US)

(21) Appl. No.: 18/835,602

(22) PCT Filed: Jan. 17, 2023
(86) PCT No.: PCT/US2023/060750

§ 371 Date: Aug. 2, 2024

(30) Foreign Application Priority Data
Feb. 3, 2022 (GB) 2201393.2

(51) Int. Cl. B60L 53/16; B60L 53/65

(52) U.S. Cl. CPC B60L 53/16; B60L 53/65; B60L 2200/40; B60L 2270/32

(57) ABSTRACT

A charging security device for an electric work vehicle comprising a battery, the charging security device comprising a lock configured to secure a charging cable to a charge port of the electric work vehicle, wherein the lock may be in a locked state or an unlocked state; a receiver configured to receive from a transmitter a signal indicative of an operator identifier; and a processor configured to compare the operator identifier against a list of authorized operators. In an event that the operator identifier corresponds to an authorized operator, the charging security device is configured to allow the state of the lock to be changed and allow charging to be initiated. In an event that the operator identifier does not correspond to an authorized operator, the charging security device is configured to prevent the state of the lock from being changed from the locked state to the unlocked state and prevent initiation of charging.

### FIELD OF THE DISCLOSURE

The disclosure relates to the field of electric work vehicles.

### BACKGROUND

Electric work vehicles are typically charged via removable charge cables. These charging cables are expensive and so it is beneficial to secure the charging cables to prevent theft. Conventionally, the charging cables are physically locked to the electric work vehicle and require an operator to actively unlock them in order to connect or disconnect the electric work vehicle to or from the charger using the charging cable. This may be time consuming, and the security may be limited if keys are generic or shared between operators. For example, a generic or shared key may allow charging cables to be stolen or may allow electric work vehicles to be disconnected from a charger without the operator's knowledge, so that the operator returns to an electric work vehicle that is not sufficiently charged.

Battery health is another important consideration in charging electric work vehicles, and it may be beneficial to prevent untrained operators from charging electric work vehicles.

### SUMMARY OF THE DISCLOSURE

Against this background, there is provided a charging security device for an electric work vehicle comprising a battery. The charging security device comprises a lock configured to secure a charging cable to a charge port of the electric work vehicle, wherein the lock may be in a locked state or an unlocked state. The charging security device further comprises a receiver configured to receive from a transmitter a signal indicative of an operator identifier. The charging security device further comprises a processor configured to compare the operator identifier against a list of authorized operators. In an event that the processor determines that the operator identifier corresponds to an authorized operator, the charging security device is configured to allow the state of the lock to be changed and allow charging of the work vehicle to be initiated. In an event that the processor determines that the operator identifier does not correspond to an authorized operator, the charging security device is configured to prevent the state of the lock from being changed from the locked state to the unlocked state and prevent initiation of charging of the electric work vehicle.

In this way, only authorized operators are able to begin charging of the battery. This may help to maintain battery health, since only trained operators may be able to charge the battery. The trained operators may charge the battery at an appropriate charge rate, for example, that is beneficial for battery health. Furthermore, only authorized operators are able to remove the charging cable from the electric work vehicle, preventing both theft of the cable and unauthorized operators from disconnecting and using the electric work vehicle.

There is also provided a method of charging an electric work vehicle comprising a battery and a charging security device. The charging security device comprises a lock configured to secure a charging cable to a charge port of the electric work vehicle, wherein the lock may be in a locked state or an unlocked state. The charging security device further comprises a receiver configured to receive from a transmitter a signal indicative of an operator identifier. The charging security device further comprises a processor configured to compare the operator identifier against a list of authorized operators. In an event that the processor determines that the operator identifier corresponds to an authorized operator, the method comprises allowing the state of the lock to be changed and allowing charging of the work vehicle to be initiated. In an event that the processor determines that the operator identifier does not correspond to an authorized operator, the method comprises preventing the state of the lock from being changed from the locked state of the unlocked state and preventing initiation of charging of the electric work vehicle.

### BRIEF DESCRIPTION OF THE DRAWINGS

A specific embodiment of the disclosure will now be described, by way of example only, with reference to the accompanying drawings in which:

FIG. 1 shows a schematic drawing of a charging port of an electric work vehicle.

FIG. 2 shows a schematic drawing of a perspective view of a charging port of an electric work vehicle.

FIG. 3 shows a schematic drawing of a charging cable connector attached to a charging port of an electric work vehicle.

FIG. 4 shows a schematic drawing of a perspective view of a charging cable connector attached to a charging port of an electric work vehicle.

FIG. 5 shows a flow chart indicating a method of charging an electric work vehicle in accordance with an embodiment of the present disclosure.

### DETAILED DESCRIPTION

A charging security device for an electric work vehicle comprising a battery may be configured to allow authorized operators to lock and unlock a charging cable at the electric work vehicle. The charging security device comprises a lock configured to secure a charging cable to a charge port of the electric work vehicle, wherein the lock may be in a locked state or an unlocked state. The lock may be in the locked state when the electric work vehicle is charging, or when the electric work vehicle is not charging. The lock may be in the unlocked state when the electric work vehicle is charging, or when the electric work vehicle is not charging. The charging security device further comprises a receiver configured to receive from a transmitter a signal indicative of an operator identifier, and a processor configured to compare the operator identifier against a list of authorized operators. In an event that the processor determines that the operator identifier corresponds to an authorized operator, the charging security device is configured to allow changing the state of the lock and allow charging of the work vehicle. In an event that the processor determines that the operator identifier does not correspond to an authorized operator, the charging security device is configured to prevent changing the state of the lock from the locked state to the unlocked state and prevent charging of the electric work vehicle.

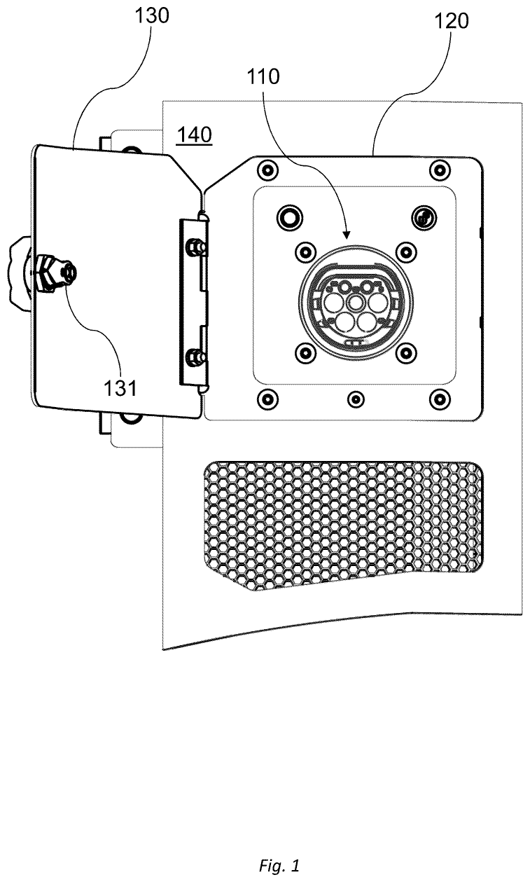

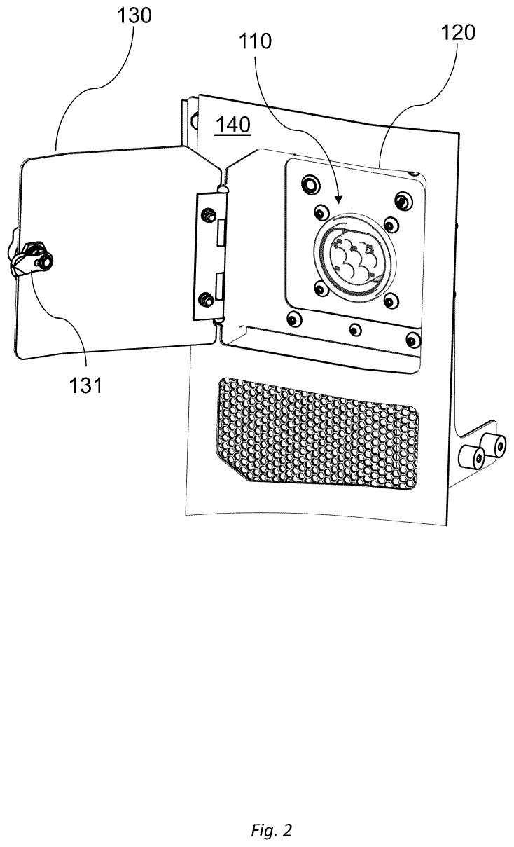

With reference to FIGS. 1 and 2, a charging cable may be configured to attach to and detach from an electric vehicle at a charge port 110. The lock may be configured to secure the charging cable to the charge port. When the charging cable is attached to the charge port and the lock is in the locked state, removal of the charging cable from the charge port is prevented.

When the charging cable is attached to the charge port and the lock is in the unlocked state, removal of the charging cable from the charge port is possible. When the lock is in the unlocked state, the charging cable may stay in place until an operator removes it.

FIGS. 1 and 2 show an exemplary arrangement of the charge port 110 in the electric work vehicle. The charge port 110 may be housed in a charge port compartment 120. The charge port compartment 120 may be covered by a door 130. In the exemplary arrangement shown in FIGS. 1 and 2 the door 130 comprises a hinged door. It will be understood that the door 130 may instead comprise a sliding door, a door that is opened and closed via rotation in the plane of the door, or another type of door. The door 130 may be secured with or without a door lock. The door lock may be configured to be locked and unlocked by a key, wherein the key may be a mechanical key, a Bluetooth key fob, or other key. The door lock may be configured such that it may be locked or unlocked by the key without any additional authorization of the operator. In the exemplary embodiment shown in FIGS. 1 and 2, the door 130 is secured via a latch 131 that may be secured and released with or without a key. The charge port compartment 120 may be recessed into the body of the electric work vehicle (exterior surface 140 of the electric work vehicle is indicated in FIGS. 1 and 2). When the door 130 is closed, door 130 may be in the plane of the exterior surface 140, or proximate to the plane of the exterior surface 140.

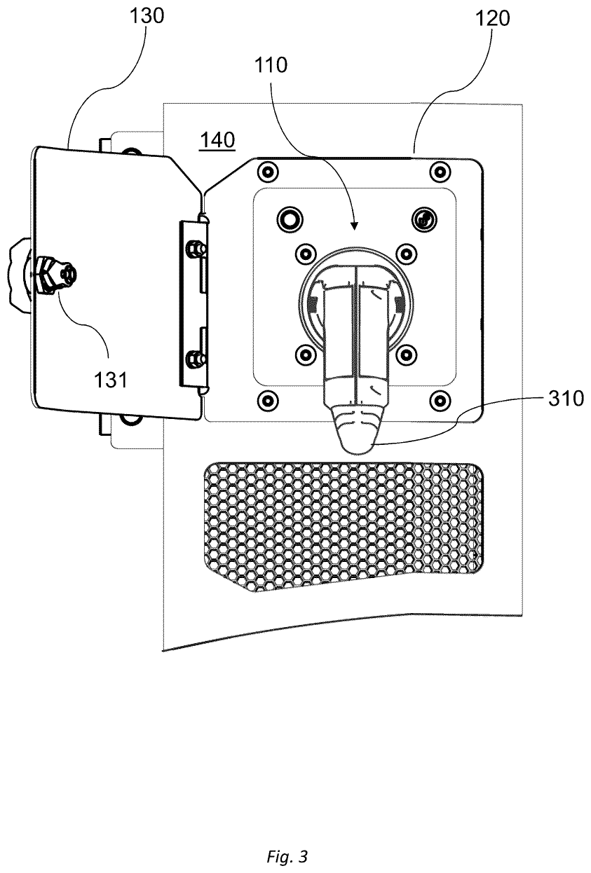

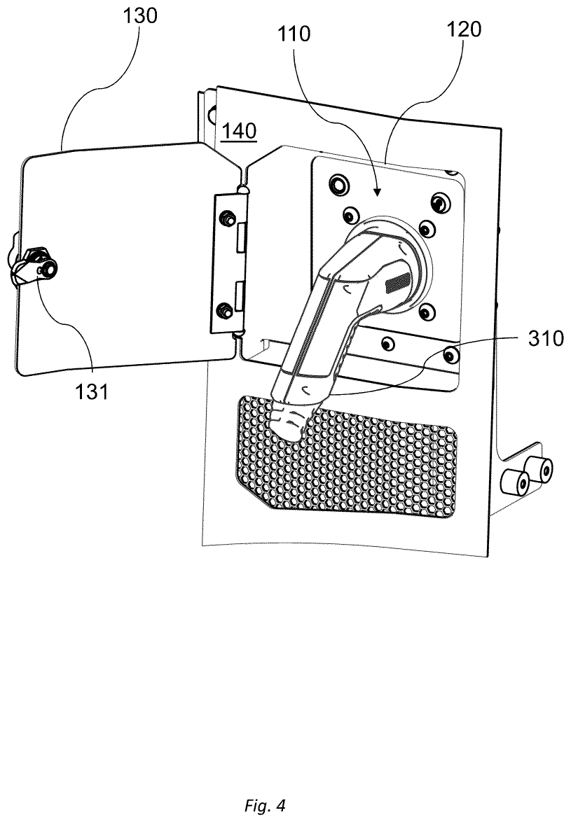

FIGS. 3 and 4 show the same exemplary arrangement as shown in FIGS. 1 and 2, with a charging cable connector 310 in situ. Only the connector 310 of the charging cable that is configured to be attached to the charge port is shown; the cable itself is omitted for clarity. It will be understood that the cable will continue, and that the opposing end of the charging cable will be configured to attach to a charger.

The operator identifier may be received wirelessly, for example via wireless internet, Bluetooth, phone signal, or other transmittable signal. The receiver may receive the signal from the transmitter when the receiver and transmitter are proximate to one another, and/or the transmitter may transmit the signal when the receiver and transmitter are proximate to one another. In an embodiment, the receiver may receive the signal from the transmitter automatically when the receiver and transmitter are proximate to one another. The transmitter may transmit the signal to the receiver automatically when the receiver and transmitter are proximate to one another. For example, the receiver may receive the signal from the transmitter and/or the transmitter may transmit the signal to the receiver when the transmitter is within a threshold radius from the receiver. In another embodiment, the transmitter may transmit the signal on command from the operator. For example, the operator may press a button on the transmitter or provide a command via a smart phone or other device. In another embodiment, the receiver may receive the signal from the transmitter or the transmitter may transmit the signal to the receiver when the operator attempts to carry out a charging operation. The charging operation may comprise one or more of connecting the charging cable to the electric work vehicle, a request to disconnect the charging cable from the electric work vehicle, a request to begin charging, a request to stop charging, and any other action associated with charging.

A key may comprise the transmitter, such that the operator identifier may be received from a key when the key is in proximity with the electric work vehicle. The operator identifier may be received from the key via Bluetooth. A smartphone may comprise the transmitter. The operator identifier may be received from the smartphone via Bluetooth, phone signal, wireless internet or other means.

In an embodiment, the charging security device may be configured to compare the operator identifier against a list of authorized operators upon receipt of the operator identifier at the receiver. In another embodiment, the charging security device may be configured to compare the operator identifier against a list of authorized operators upon the charging cable being connected to the electric work vehicle. The charging security device may be configured to compare the operator identifier against a list of authorized operators upon a request to disconnect the charging cable from the electric work vehicle.

A request to disconnect the charging cable from the electric work vehicle may be made by pressing a button or a switch. In the event that the operator is an authorized operator the request to disconnect the charging cable from the electric work vehicle may change the state of the lock to its unlocked state, allowing the charging cable to be removed from the electric work vehicle.

In use, authorization of the operator may be required for at least starting charging and disconnecting the charging cable. The authorized operator for starting charging and for disconnecting the charging cable may be the same authorized operator or different authorized operators. In this way, one authorized operator may start the charge (for example at the end of their shift), and another authorized operator may disconnect the charging cable in order to use the electric work vehicle (for example at the start of their shift). In an embodiment, authorization of the operator may not be required for connecting the charging cable to the electric work vehicle or for stopping charging. For example, an unauthorized operator may be able to connect the charging cable to the electric work vehicle but would not be able to change the state of the lock from the locked state to the unlocked state or start charging. An unauthorized operator may be able to stop charging, for example in an emergency. In an embodiment, an unauthorized operator may be prevented from changing the state of the lock from the unlocked state to the locked state. In an embodiment an unauthorized operator may be able to change the state of the lock from the unlocked state to the locked state.

The charging security device may be further configured to record charge data. The charge data may comprise one or more of the operator identifier; a start time of charging; a stop time of charging; a duration of charging; a charge method; an initial state of charge at the start of charging; a final state of charge at the stop time of charging; a change in state of charge of the battery during charging; a rate of charging; a value of kilowatt hour used during charging; a cost of charging; a battery temperature during charging; and data indicative of battery health. The start time and stop time may comprise time or date or both time and date. The data indicative of battery health may comprise any metrics related to the battery, and may include data recorded over the duration of charging (and may therefore encompass variations in the metrics). The metrics may comprise rate of charge, temperature, state of charge, current, or any other metric related to the battery and charging the battery.

The recorded charge data may be used for data analysis. The recorded charge data may be used for preferred charge settings. The preferred charge settings may comprise times for charging that are cost effective. The preferred charge settings may correspond to a particular authorized operator, for example their preferred return to work time, charge method or final state of charge. The preferred charge settings may be saved as defaults against the operator identifier, such that the preferred charge settings are used as default when the particular authorized operator next connects the charging cable or starts a charge.

The charging cable may connect electrically to the electric vehicle via pins and a socket. The charge port may comprise the pins and the charging cable may comprise the socket. The charge cable may connect physically to the electric vehicle by inserting the charge cable connector into a recess of the charge port, similarly to a plug and socket arrangement. However, it will be understood that although the charge cable may be physically inserted into the charge port, it is the charge cable that comprises the electrical socket and the charge port that comprises the electrical pins.

The lock may comprise a locking mechanism, such as a retractable pin or other mechanical locking means. The lock may comprise a locking solenoid. The lock may be electrically operated.

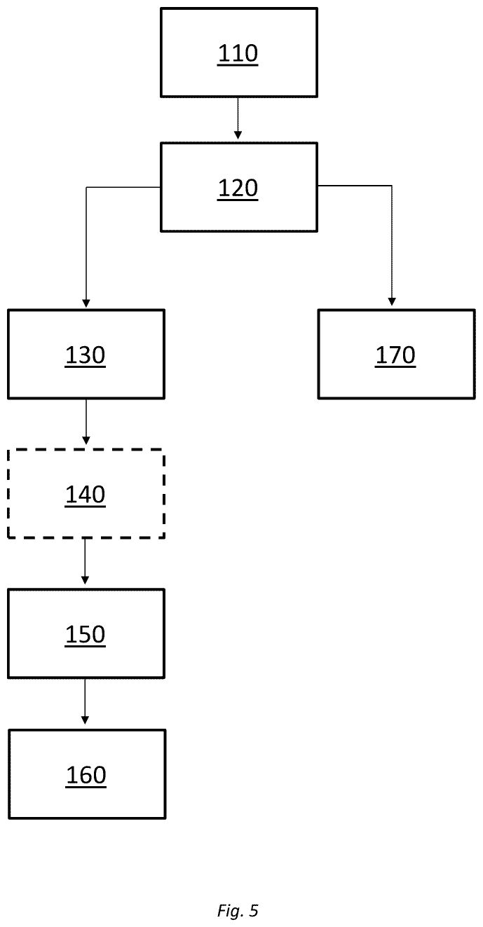

In use, with reference to FIG. 5, an operator may connect the charging cable to the electric work vehicle at step 110. This may trigger various checks. The checks comprise comparing the operator identifier against a list of authorized operators at step 120. The checks may comprise safety checks or operational checks, such as checking whether the cable and/or charger are appropriate for the electric work vehicle. In an event that the operator is an authorized operator, a charging mode may be activated at step 130 that allows the lock to be changed to its locked state and charging to be started. The lock may be changed to its locked state by a request from the operator prior to starting charging (shown as dashed step 140), or automatically when a request to charge is provided. The charging may be started by a request to charge from the operator at step 150. In an embodiment, the request to charge may comprise a request to charge immediately, or a request to charge at some later time. The request to charge may comprise one or more of a charging time, charging rate, target state of charge and return to work time. In another embodiment, the request to charge may simply be an instruction that the electric work vehicle should be charged. A controller may then determine one or more of a charging time, charging rate and target state of charge. When charging has finished, an authorized operator may change the state of the lock to the unlocked state at step 160 and remove the charging cable from the electric work vehicle. In an event that at step 120 the operator is determined not to be an authorized operator, at step 170 the operator is prevented from changing the state of the lock and from starting charging.

A method of charging an electric work vehicle comprising a battery and a charging security device may be configured to allow authorized operators to lock and unlock a charging cable at the electric work vehicle. The charging security device comprises a lock configured to secure a charging cable to the electric work vehicle, wherein the lock may be in a locked state or an unlocked state. The charging security device further comprises a receiver configured to receive from a transmitter a signal indicative of an operator identifier, and a processor configured to compare the operator identifier against a list of authorized operators. In an event that the processor determines that the operator identifier corresponds to an authorized operator, the method comprises allowing changing the state of the lock and allowing charging of the work vehicle. In an event that the processor determines that the operator identifier does not correspond to an authorized operator, the method comprises preventing changing the state of the lock and preventing charging of the electric work vehicle.

The method may further any steps described above in relation to the charging security device.

1. A charging security device for an electric work vehicle comprising a battery, the charging security device comprising:
a lock configured to secure a charging cable to a charge port of the electric work vehicle, wherein the lock may be in a locked state or an unlocked state;
a receiver configured to receive from a transmitter a signal indicative of an operator identifier; and
a processor configured to compare the operator identifier against a list of authorized operators;
wherein in an event that the processor determines that the operator identifier corresponds to an authorized operator, the charging security device is configured to allow the state of the lock to be changed and allow charging of the work vehicle to be initiated; and
wherein in an event that the processor determines that the operator identifier does not correspond to an authorized operator, the charging security device is configured to prevent the state of the lock from being changed from the locked state to the unlocked state and prevent initiation of charging of the electric work vehicle.

2. The charging security device of claim 1, wherein the operator identifier is received from a key when the key is in proximity with the electric work vehicle.

3. The charging security device of claim 2, wherein the operator identifier is received from the key via Bluetooth.

4. The charging security device of claim 2, wherein the charging security device is configured to compare the operator identifier against a list of authorized operators upon the charging cable being connected to the electric work vehicle.

5. The charging security device of claim 2, wherein the charging security device is configured to compare the operator identifier against a list of authorized operators upon a request to disconnect the charging cable from the electric work vehicle.

6. The charging security device of claim 5, wherein the request to disconnect the charging cable from the electric work vehicle is made by pressing a button or a switch.

7. The charging security device of claim 5, wherein the charging security device is further configured to record charge data comprising at least one of:
the operator identifier;
a start time of charging;
a stop time of charging;
a duration of charging;
a charge method;
an initial state of charge of the battery at the start of charging;
a final state of charge of the battery at the end of charging;
a rate of charging;
a change in state of charge of the battery during charging;
a value of kilowatt hour used during charging;
a cost of charging;
a battery temperature during charging; and
data indicative of battery health.

8. The charging security device of claim 7, wherein the charge data is recorded against the operator identifier.

9. A method of charging an electric work vehicle comprising a battery and a charging security device, the charging security device comprising:
a lock configured to secure a charging cable to the electric work vehicle, wherein the lock may be in a locked state or an unlocked state;
a receiver configured to receive from a transmitter a signal indicative of an operator identifier; and
a processor configured to compare the operator identifier against a list of authorized operators;
wherein the method comprises:
in an event that the processor determines that the operator identifier corresponds to an authorized operator, allowing the state of the lock to be changed and allowing charging of the work vehicle; and
in an event that the processor determines that the operator identifier does not correspond to an authorized operator, preventing the state of the lock from being changed and preventing charging of the electric work vehicle.

10. The method of claim 9, wherein the operator identifier is received from a key when the key is in proximity with the electric work vehicle.

11. The method of claim 9, wherein the operator identifier is received from the key via Bluetooth.

12. The method of of claim 9, wherein the charging security device is configured to compare the operator identifier against a list of authorized operators upon the charging cable being connected to the electric work vehicle.

13. The method of of claim 9, wherein the charging security device is configured to compare the operator identifier against a list of authorized operators upon a request to disconnect the charging cable from the electric work vehicle.

14. The method of claim 13, wherein the request to disconnect the charging cable from the electric work vehicle is made by pressing a button or a switch.

15. The method of of claim 9, wherein the charging security device is further configured to record charge data comprising at least one of:
the operator identifier;
a start time of charging;
a stop time of charging;
a duration of charging;
a charge method;
an initial state of charge of the battery at the start of charging;
a final state of charge of the battery at the end of charging;
a rate of charging;
a change in state of charge of the battery during charging;
a value of kilowatt hour used during charging;
a cost of charging;
a battery temperature during charging; and
data indicative of battery health.
